(19) United States
(12) Patent Application Publication
(10) Pub. No.: US 2022/0036202 A1
(43) Pub. Date: Feb. 3, 2022

(54) AI Based Traffic Classification

(71) Applicant: Parallel Wireless, Inc., Nashua, NH (US)

(72) Inventors: Murli Sivashanmugam, Bangalore (IN); Babu Rajagopal, Bangalore (IN); Seshashayi Thalluri, Bangalore (IN)

(21) Appl. No.: 17/387,979

(22) Filed: Jul. 28, 2021

Related U.S. Application Data
(60) Provisional application No. 63/057,294, filed on Jul. 28, 2020.

(51) Int. Cl. G06N 5/02; H04W 24/08

(52) U.S. Cl. CPC G06N 5/02; H04W 84/045; H04W 24/08

(57) ABSTRACT

Systems, methods and computer software are disclosed for providing intelligent traffic classification at a mobile edge using Artificial Intelligence (AI). In one embodiment, a method is disclosed, comprising: receiving a packet; performing Prediction Function (PF) feature extraction on the packet; performing, using a light weight AI model, traffic type classification for the packet based on the feature extraction; performing Learning Function (LF) feature extraction on the packet; determining, using a heavy weight AI model, features and predictions for the packet; classifying the packet by the heavy weight AI model; and sending a determined traffic class to the light weight AI model.

### CROSS-REFERENCE TO RELATED APPLICATIONS

This application claims priority under 35 U.S.C. § 119(e) to U.S. Provisional Pat. App. No. 63/057,294, filed Jul. 28, 2020, titled “AI Based Traffic Classification” which is hereby incorporated by reference in its entirety for all purposes. T This application hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. pat. app. Ser. No. 14/034,915, “Dynamic Multi-Access Wireless Network Virtualization,” filed Sep. 24, 2013; U.S. pat. app. Ser. No. 14/289,821, “Method of Connecting Security Gateway to Mesh Network,” filed May 29, 2014; U.S. pat. app. Ser. No. 14/500,989, “Adjusting Transmit Power Across a Network,” filed Sep. 29, 2014; U.S. pat. app. Ser. No. 14/506,587, “Multicast and Broadcast Services Over a Mesh Network,” filed Oct. 3, 2014; U.S. pat. app. Ser. No. 14/510,074, “Parameter Optimization and Event Prediction Based on Cell Heuristics,” filed Oct. 8, 2014, U.S. pat. app. Ser. No. 14/642,544, “Federated X2 Gateway,” filed Mar. 9, 2015, and U.S. pat. app. Ser. No. 14/936,267, “Self-Calibrating and Self-Adjusting Network,” filed Nov. 9, 2015; U.S. pat. app. Ser. No. 15/607,425, “End-to-End Prioritization for Mobile Base Station,” filed May 26, 2017; U.S. pat. app. Ser. No. 15/803,737, “Traffic Shaping and End-to-End Prioritization,” filed Nov. 27, 2017, each in its entirety for all purposes, having attorney docket numbers PWS-71700U501, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. pat. app. Ser. No. 14/822,839, U.S. pat. app. Ser. No. 15/828,427, U.S. Pat. App. Pub. Nos. US20170273134A1, US20170127409A1 in their entirety. Features and characteristics of and pertaining to the systems and methods described in the present disclosure, including details of the multi-RAT nodes and the gateway described herein, are provided in the documents incorporated by reference.

This document also hereby incorporates by reference U.S. Pat. Nos. 9,107,092, 8,867,418, and 9,232,547 in their entirety. This document also hereby incorporates by reference U.S. pat. app. Ser. No. 14/822,839, U.S. pat. app. Ser. No. 15/828,427, U.S. Pat. App. Pub. Nos. US20170273134A1, US20170127409A1 in their entirety.

This application also hereby incorporates by reference in their entirety each of the following U.S. Pat. applications or Pat. App. Publications: US20180242396A1 (PWS-72501U502); US20150098387A1 (PWS-71731US01); US20170055186A1 (PWS-71815U501); US20170273134A1 (PWS-71850U501); US20170272330A1 (PWS-71850U502); and Ser. No. 15/713,584 (PWS-71850US03). This application also hereby incorporates by reference in their entirety U.S. pat. application Ser. No. 16/424,479, “5G Interoperability Architecture,” filed May 28, 2019; and U.S. Provisional Pat. Application No. 62/804,209, “5G Native Architecture,” filed Feb. 11, 2019.

Features and characteristics of and pertaining to the systems and methods described in the present disclosure, including details of the multi-RAT nodes and the gateway described herein, are provided in the documents incorporated by reference.

### BACKGROUND

Network providers have used Deep Packet Inspection (DPI) in the past to gain insight into the traffic flowing through their infrastructure. They used this insight to throttle and prioritize the traffic so that critical applications don't see any service degrade. Over a period of time when most of the traffics were end-to-end encrypted, the deep packet inspection approach was not able to identify and classify the traffic type. The network providers then started using rule-based algorithms to classify network traffic. The rule-based algorithms use traffic patterns like the number of packets per second, packet sizes, delay patterns, etc. to classify traffic types. The rule-based traffic pattern classification is still the widely used approach for traffic classification. But the disadvantage of rule-based traffic pattern classification is that it is difficult to keep up with new applications, changing traffic patterns across different application versions, etc. and hence are mostly ineffective. Instead of hand-coding the rules, AI models can be used to learn the traffic pattern and classify the traffic types more efficiently and quickly.

The effectiveness of AI for classifying encrypted traffic is already established in many publication and public literature. But its practical and deployment aspects of how to integrate AI into a network service and what use cases it will help solve are not well explored.

### SUMMARY

A method, system and compute readable medium are disclosed for performing AI based traffic classification are disclosed. Two types of models are used, a light weight model and a heavy weight model for traffic classification.

In one embodiment, a method may be disclosed, the method including receiving a packet; performing Prediction Function (PF) feature extraction on the packet; performing, using a light weight AI model, traffic type classification for the packet based on the feature extraction; performing Learning Function (LF) feature extraction on the packet; determining, using a heavy weight AI model, features and predictions for the packet; classifying the packet by the heavy weight AI model; and sending a determined traffic class to the light weight AI model.

In another embodiment, a system may be provided for providing intelligent traffic classification at a mobile edge using Artificial Intelligence (AI). The system includes a Converged Wireless System (CWS); and a Het Net Gateway (HNG) in communication with the CWS; wherein the CWS receives a packet; performs Prediction Function (PF) feature extraction on the packet; performs, using a light weight AI model, traffic type classification for the packet based on the feature extraction; and performs Learning Function (LF) feature extraction on the packet; wherein the HNG determines, using a heavy weight AI model, features and predictions for the packet; classifies the packet; and sends a determined traffic class to the light weight AI model.

In another embodiment a non-transitory computer-readable medium contains instructions for providing AI based traffic classification, which, when executed, cause the system to perform steps comprising: receiving a packet; performing Prediction Function (PF) feature extraction on the packet; performing, using a light weight AI model, traffic type classification for the packet based on the feature extraction; performing Learning Function (LF) feature extraction on the packet; determining, using a heavy weight AI model, features and predictions for the packet; classifying the packet by the heavy weight AI model; and sending a determined traffic class to the light weight AI model.

### BRIEF DESCRIPTION OF THE DRAWINGS

FIG. 1 is a system diagram for AI based traffic classification, in accordance with some embodiments.

FIG. 2 is a bootup call flow, in accordance with some embodiments.

FIG. 3 is a flow diagram showing traffic class prediction, in accordance with some embodiments.

FIGS. 4A and 4B are a call flow diagram for network slice-based traffic analysis core, in accordance with some embodiments.

FIG. 5 is a block diagram showing prediction functions, in accordance with some embodiments.

FIGS. 6A and 6B are a call flow diagram for IP classification, in accordance with some embodiments.

FIG. 7 is a system diagram for real-time monitoring and control, in accordance with some embodiments.

FIG. 8 is a diagram for a hierarchical distributed instance, in accordance with some embodiments.

FIG. 9 is diagram showing timing constraints and intents, in accordance with some embodiments.

FIG. 10 is a diagram showing hierarchical instances, in accordance with some embodiments.

### DETAILED DESCRIPTION

Current rule-based traffic for classifying encrypted traffic is ineffective. Even though complex rule-based algorithms do a good enough job in classifying some of the traffic types, keep them updated with new pattern changes across versions and the new application is a manual process and is a highly skillful and time-consuming operation. AI models can be trained to learn the rules automatically instead of manually coding the rules. There are different types of AI models some are lightweight like decision trees or clustering types of models and some are heavyweight like LSTM with encoder-decoders, Siamese network, etc. Generally, lightweight models user lesser resources and less accurate/confidence in classifying traffic and heavyweight models need high resources like GPU and are more accurate/confidant in classification. For 5G types of the networks, we need to do classification on the edge nodes like vRU where resources would be limited and hence the accuracy/confidence is also lower.

There are many types of AI models, few basic models are based on simple probalistic distribution like linear regression and some are based on more complex convoluted distributions like encode-decoder models or Siamese net. Simple models like probability distribution models like linier regression or light weight neural networks like mobile net can be run on x86 processor and the complex algorithms like encoder-decoder models or Siamese net need good amount of GPU to do the prediction in a reasonable time. As GPUs need lots of power and generate lots of heat and hence it is not practical to add GPUs to edge nodes like vRU/DU. But on the other hand GPUs can be added to centralized entities like HNG/CU.

The idea is to use two types of models, light weight and heavy weight models for traffic classification. The light weight model will run in CWS/DU (close to input of traffic) and classify the traffic. For those traffic types the light weight model can't classify, the packet traces along with metadata like time of day, location, etc. are sent to HNG/CU. HNG/CU will analyze the traffic with heavy weight model and send back the classification type to CWS/DU. HNG/DU will also archive these packet traces from CWS/DU and the classified traffic class. This information is used to periodically train the light weight model automatically or manually and updated light weight model. Updated model is then pushed by HNG/CU to CWS/DU so that further traffic has better chance to be classified at CWS/DU itself and thus reducing the load on HNG/DU.

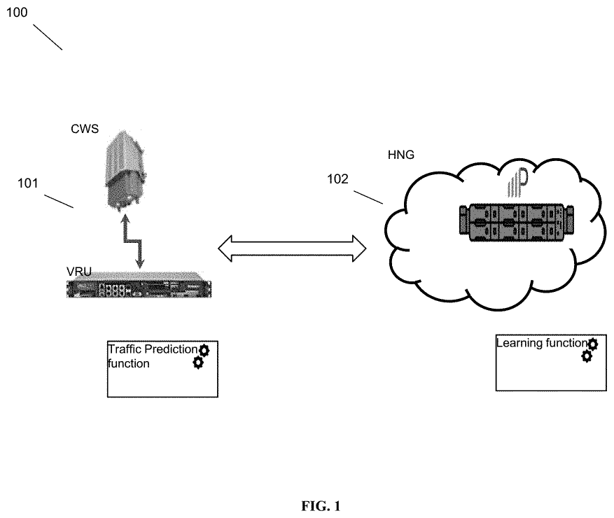

FIG. 1 shows architecture 100 for intelligent traffic classification, which consists of two major components: Traffic prediction function at the edge called Prediction function (PF) 101 and Learning function (LF) 102 in the cloud as part of HNG Cluster.

The prediction function at the edge analyses the traffic seen at the vRU to classify the traffic using light weight AI models.

For any traffic which cannot be classified at the edge, the data is archived and sent to Learning Function in the cloud for further analysis.

The learning function at the core employs heavy weight AI algorithms or use third party provided APIs to classify the traffic. Once the traffic is classified it will send back the traffic class to Traffic Prediction Function. The learning function is also archive the packets and predicted traffic class. This information is used to periodically retrain the light weight model and the updated light weight model is pushed to vRU.

Another perspective to Learning Function is like AutoML, periodically with archived data it determines the appropriate model and train model parameters to classify it, and pushes it to vRU automatically.

Some of the features that can be extracted for traffic classification include: port number; number of packets; number of bytes; packet inter-arrival time; number of flows; and flow duration.

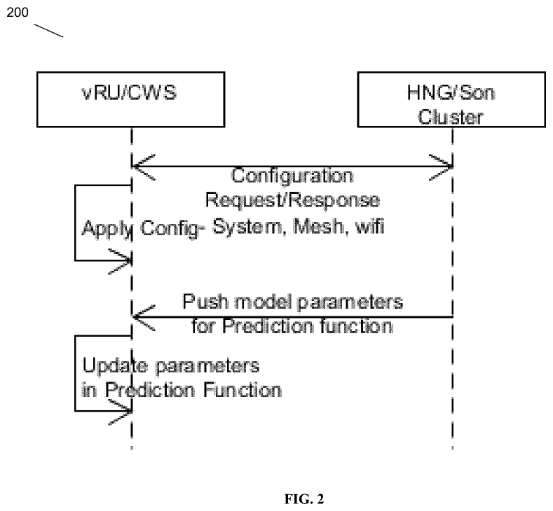

FIG. 2 shows call flow 200 during startup. During vRU bootup, the initial configuration is requested from HNG and applied in vRU. After initial configuration is done, vRU requests for parameters for Prediction function. There can be multiple prediction profiles associated with a vRU. Using multiple profiles, different parameters can be applied for prediction. Some examples of profiles: Profile 1—LSTM with 4 layers, Profile 2—CNN Etc.

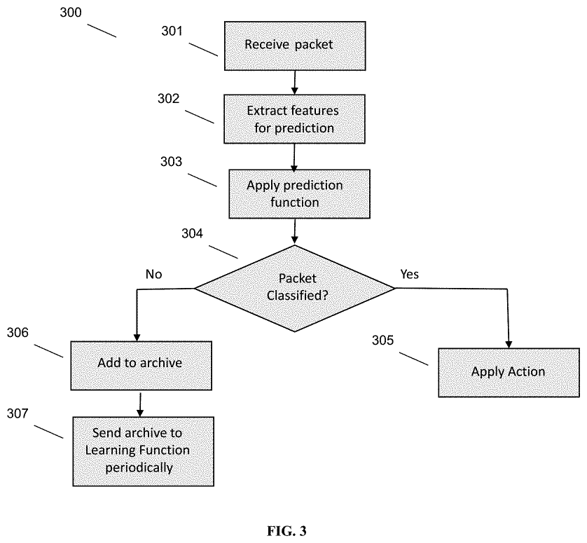

FIG. 3 shows a flow diagram 300 for traffic class prediction. A packet is received (301) and features are extracted for prediction (302). The prediction function is applied (303). A determination is made whether the packet was classified (304). If the packet was classified, then the action is applied (305). If the packet wasn't able to be classified then the packet is added to an archive (306) . The archive is sent to the learning function periodically (307).

Use Case 1

Change network slice-based on traffic analysis.

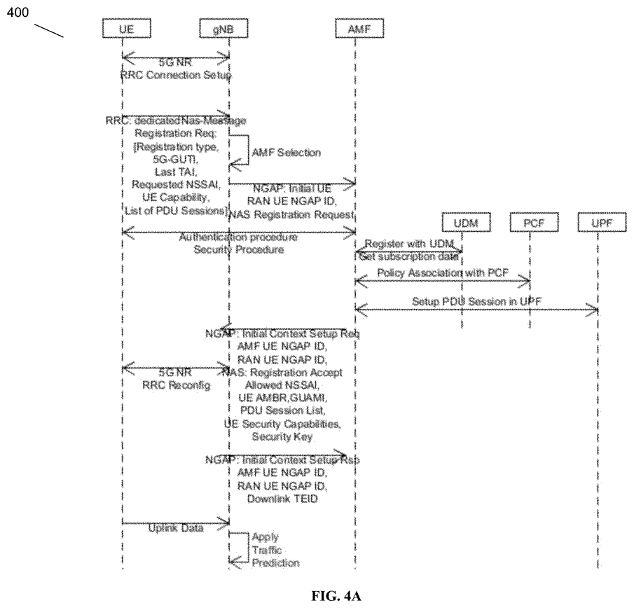

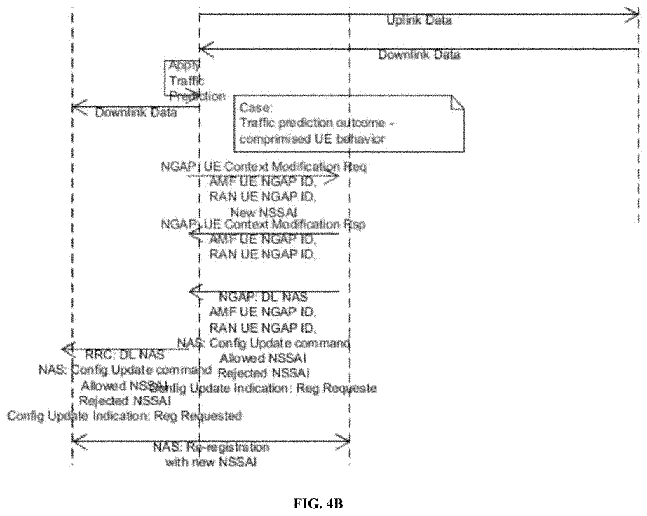

The idea is that, with 5G network slices, the slice selection is done by UE. Once UE attaches it to a slice there is no way to make sure that UE is using the slice as it is expected to. There is a good possibility that a rouge UE could misuse the slice. A rough UE might use a slice meant for IOT to send whatsapp messages. Or use a slice meant for video communication to do file transfers, etc. By integrating a AI based traffic classifier in gNB, the gNB can police if the UE traffic type is matching to the slice use case. If not gNB can send an update message (ContextModification) message to AMF and AMF will trigger a re-register to UE and AMF will offer a low priority slice to UE during re-registration. The related call flow 400 is shown in FIGS. 4A and 4B.

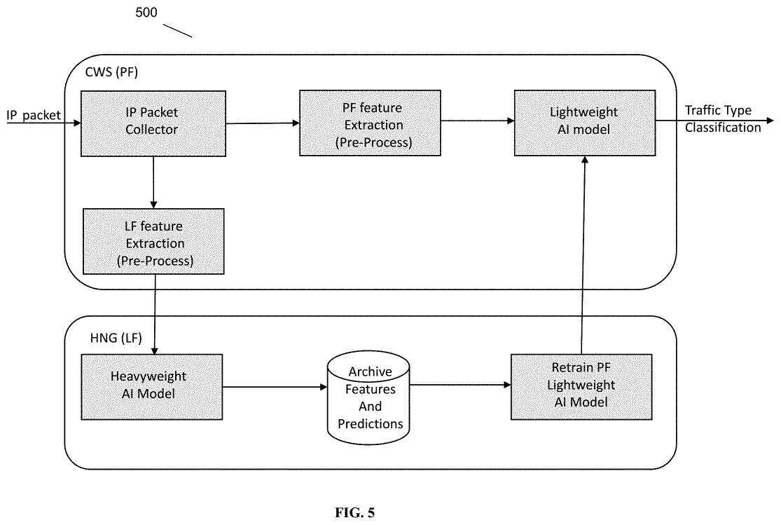

FIG. 5 shows a block diagram of the system 500 with a prediction function based in the CWS and the learning function based in the HNG.

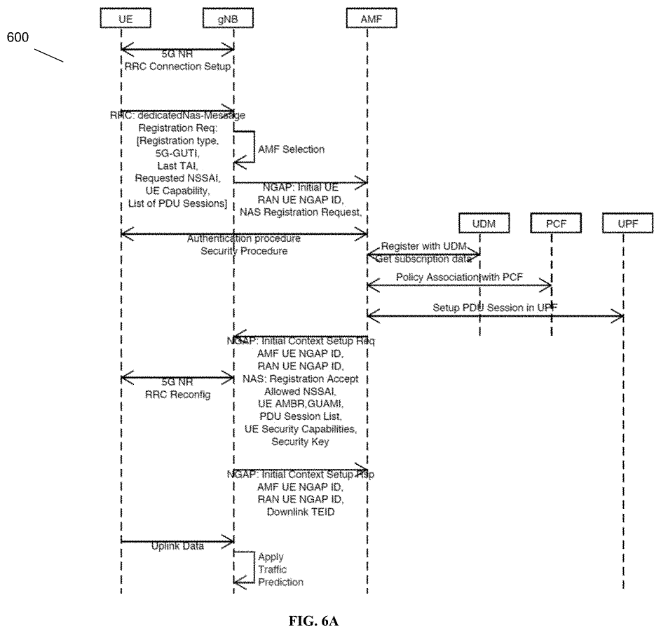

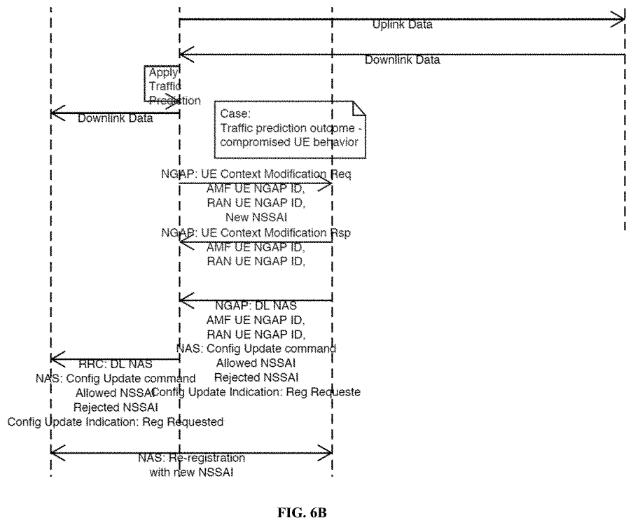

FIGS. 6A and 6B shows a call flow for IP TOS/DSCP classification. Based on traffic class we can set different TOS/DSCP values on the IP packet for traffic throttling. We will have a better insight into encrypted traffic and hence prioritize traffic and resources efficiently. Competitors don't use AI model as they are high resource consumption. With two-stage classification, we can classify traffic mode effectively as well as efficient in terms of resource usage and network load. We take advantage of parallel wireless architecture to deploy an efficient solution.

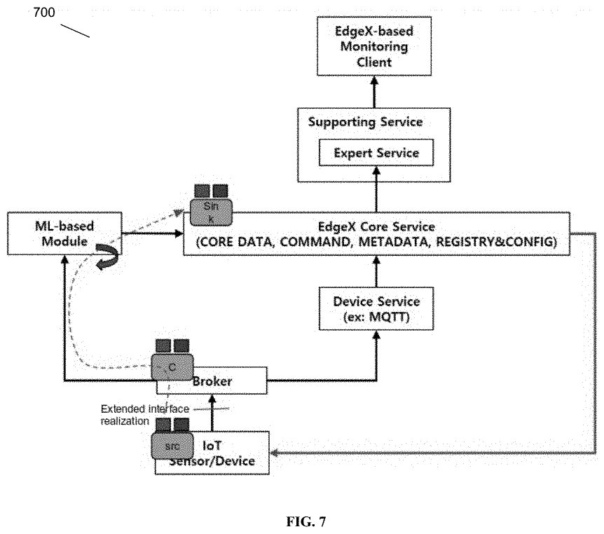

FIG. 7 shows a system 700 for performing real-time monitoring and control system using EdgeX.

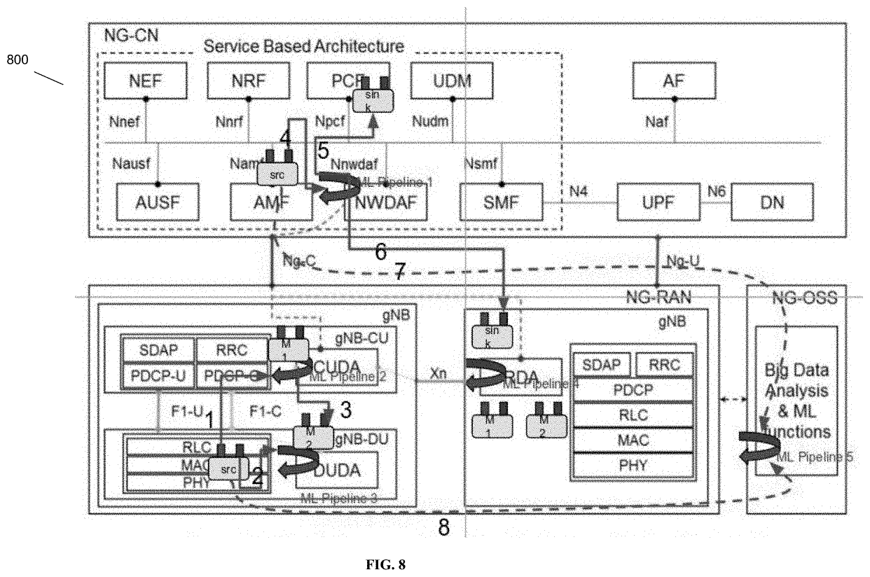

FIG. 8 shows an instance 800 with the following characteristics. In an SBA, the ML pipeline is hosted in the network data analytics function (NWDAF) [1]. ML pipeline 1 may have AMF as src (arrow 4) and PCF as sink (arrow 5) to realize a particular use case (e.g., mobility-based policy decisions).

A resource-constrained DU hosts part of the ML pipeline, but not the training. The training is done at the CU and the trained model is distributed to the DU, where it is hosted. DU hosts M2 which is updated from the CU via arrow 3. Data for training the model in the CU is provided via arrow 1.

Collapsing of the interface between ML pipelines is an option as shown in the RAN data analytics (RDA) option. This brings out the need for flexibility in deployment. See ML-unify-012, ML-unify-015 and ML-unify-020. M1 and M2 are hosted in CUDA and DUDA (in ML pipeline 2 and 3, respectively) in the 3GPP split deployment, whereas they are collapsed (merged) in the other 3GPP alternative deployment options [1].

The extension of 3GPP interfaces for carrying information specific to ML pipeline execution and training is a requirement here. For example: RDA is primarily used to support optimization in the RAN. It also needs to provide data subscription services for NWDAF and business and operation support system (BOSS), operation support system (OSS) or MANO; and upload pre-processed subscription data to NWDAF and BOSS or OSS (arrow 8) for further big data operations and services; RDA can also subscribe to the NWDAF data analysis results for the RAN-side service optimization (arrow 6).

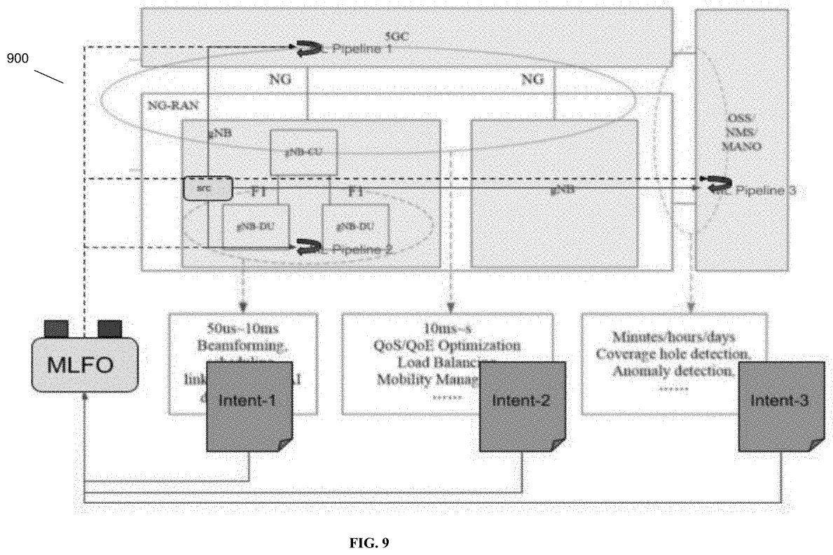

In FIG. 9, the mechanism 900 of incorporating timing constraints of various 3GPP use cases into their realization using ML pipeline is shown. The timing constraints are captured in intents, which are in turn processed by MLFO to determine instantiation choices, like positioning of various ML pipeline nodes.

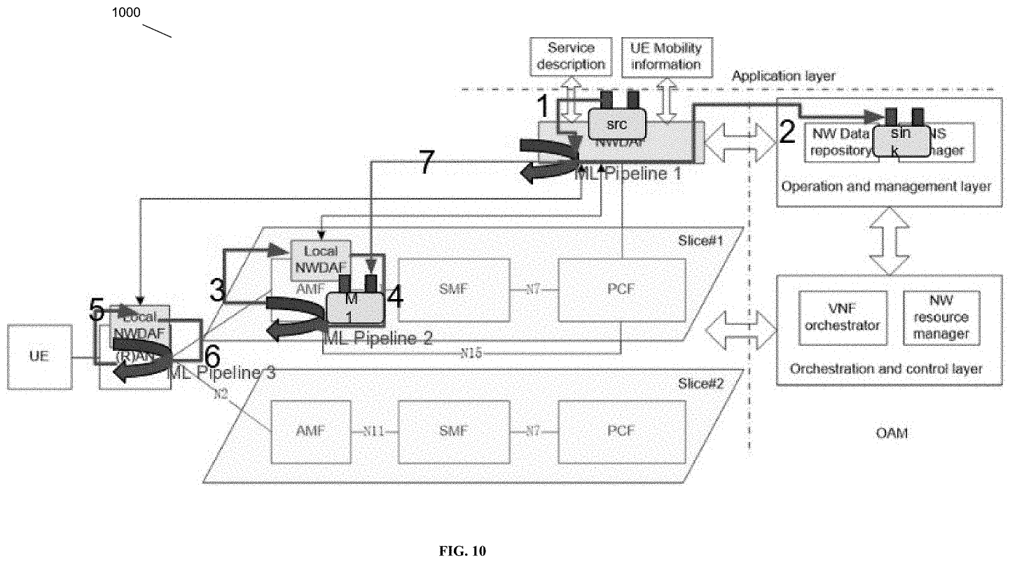

In FIG. 10, RAN use cases have the strictest latency constraints (50 μs-10 ms). Therefore, the MLFO may choose to position the entire ML pipeline 2 in the RAN. In contrast, use cases related to 5GC have 10 ms to a few seconds latency budgets. Hence, the MLFO may choose to enrich the data in ML pipeline 1 with side information from the RAN. The same is applicable to ML pipeline 3.

FIG. 10 shows a unique realization in which NWDAF functions are hierarchical across three domains: CN, AMF and RAN. This split allows certain specific data to be used for local decisions at these NFs. From an ML pipeline perspective, this would mean that the pipelines are chained, so that the output of one could feed into the input of another.

Arrow 1, arrow 2, show control by the NS manager using the ML pipeline in NWDAF. This enables use cases like dynamic slice configuration using ML.

Arrows 3,4, and 5,6 are local NWDAF functions in AMF and RAN respectively (e.g., AMF can customize connection management, registration management, mobility restriction management for UEs based on the long-term UE MPP).

Arrow 7 shows chaining, so that the output of a remote NWDAF can feed into the local NWDAF as input (e.g., while performing short term MPP).

The protocols described herein have largely been adopted by the 3GPP as a standard for the upcoming 5G network technology as well, in particular for interfacing with 4G/LTE technology. For example, X2 is used in both 4G and 5G and is also complemented by 5G-specific standard protocols called Xn. Additionally, the 5G standard includes two phases, non-standalone (which will coexist with 4G devices and networks) and standalone, and also includes specifications for dual connectivity of UEs to both LTE and NR (“New Radio”) 5G radio access networks. The inter-base station protocol between an LTE eNB and a 5G gNB is called Xx. The specifications of the Xn and Xx protocol are understood to be known to those of skill in the art and are hereby incorporated by reference dated as of the priority date of this application.

In some embodiments, several nodes in the 4G/LTE Evolved Packet Core (EPC), including mobility management entity (MME), MME/serving gateway (S-GW), and MME/S-GW are located in a core network. Where shown in the present disclosure it is understood that an MME/S-GW is representing any combination of nodes in a core network, of whatever generation technology, as appropriate. The present disclosure contemplates a gateway node, variously described as a gateway, HetNet Gateway, multi-RAT gateway, LTE Access Controller, radio access network controller, aggregating gateway, cloud coordination server, coordinating gateway, or coordination cloud, in a gateway role and position between one or more core networks (including multiple operator core networks and core networks of heterogeneous RATs) and the radio access network (RAN). This gateway node may also provide a gateway role for the X2 protocol or other protocols among a series of base stations. The gateway node may also be a security gateway, for example, a TWAG or ePDG. The RAN shown is for use at least with an evolved universal mobile telecommunications system terrestrial radio access network (E-UTRAN) for 4G/LTE, and for 5G, and with any other combination of RATs, and is shown with multiple included base stations, which may be eNBs or may include regular eNBs, femto cells, small cells, virtual cells, virtualized cells (i.e., real cells behind a virtualization gateway), or other cellular base stations, including 3G base stations and 5G base stations (gNBs), or base stations that provide multi-RAT access in a single device, depending on context.

In the present disclosure, the words “eNB,” “eNodeB,” and “gNodeB” are used to refer to a cellular base station. However, one of skill in the art would appreciate that it would be possible to provide the same functionality and services to other types of base stations, as well as any equivalents, such as Home eNodeBs. In some cases Wi-Fi may be provided as a RAT, either on its own or as a component of a cellular access network via a trusted wireless access gateway (TWAG), evolved packet data network gateway (ePDG) or other gateway, which may be the same as the coordinating gateway described hereinabove.

The word “X2” herein may be understood to include X2 or also Xn or Xx, as appropriate. The gateway described herein is understood to be able to be used as a proxy, gateway, B2BUA, interworking node, interoperability node, etc. as described herein for and between X2, Xn, and/or Xx, as appropriate, as well as for any other protocol and/or any other communications between an LTE eNB, a 5G gNB (either NR, standalone or non-standalone). The gateway described herein is understood to be suitable for providing a stateful proxy that models capabilities of dual connectivity-capable handsets for when such handsets are connected to any combination of eNBs and gNBs. The gateway described herein may perform stateful interworking for master cell group (MCG), secondary cell group (SCG), other dual-connectivity scenarios, or single-connectivity scenarios.

In some embodiments, the base stations described herein may be compatible with a Long Term Evolution (LTE) radio transmission protocol, or another air interface. The LTE-compatible base stations may be eNodeBs, or may be gNodeBs, or may be hybrid base stations supporting multiple technologies and may have integration across multiple cellular network generations such as steering, memory sharing, data structure sharing, shared connections to core network nodes, etc. In addition to supporting the LTE protocol, the base stations may also support other air interfaces, such as UMTS/HSPA, CDMA/CDMA2000, GSM/EDGE, GPRS, EVDO, other 3G/2G, legacy TDD, 5G, or other air interfaces used for mobile telephony. In some embodiments, the base stations described herein may support Wi-Fi air interfaces, which may include one of 802.11a/b/g/n/ac/ad/af/ah. In some embodiments, the base stations described herein may support 802.16 (WiMAX), or other air interfaces. In some embodiments, the base stations described herein may provide access to land mobile radio (LMR)-associated radio frequency bands. In some embodiments, the base stations described herein may also support more than one of the above radio frequency protocols, and may also support transmit power adjustments for some or all of the radio frequency protocols supported.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for providing intelligent traffic classification at a mobile edge using Artificial Intelligence (AI), comprising:
receiving a packet;
performing Prediction Function (PF) feature extraction on the packet;
performing, using a light weight AI model, traffic type classification for the packet based on the feature extraction;
performing Learning Function (LF) feature extraction on the packet;
determining, using a heavy weight AI model, features and predictions for the packet;
classifying the packet by the heavy weight AI model; and
sending a determined traffic class to the light weight AI model.

2. The method of claim 1 further comprising archiving the features and predictions for the packet.

3. The method of claim 2 further comprising training the light weight AI model using the features and predictions of the packet.

4. The method of claim 1 wherein the light weight model runs in a Converged Wireless System (CWS).

5. The method of claim 1 wherein the light weight model runs in a Distributed Unit (DU).

6. The method of claim 1 wherein the heavy weight model runs in a HNG.

7. The method of claim 1 wherein the heavy weight model runs in a Central Unit (CU).

8. The method of claim 1 wherein performing Prediction Function (PF) feature extraction on the packet includes extracting at least one of a port number, a number of packets, a number of bytes, a packet inter-arrival time, a number of flows, or a flow duration.

9. The method of claim 1 further comprising, during virtual Radio Unit (vRU) bootup, requesting an initial configuration from a HetNet Gateway (HNG).

10. The method of claim 9 further comprising requesting, by the vRU, parameters for the prediction function.

11. A system for providing intelligent traffic classification at a mobile edge using Artificial Intelligence (AI), comprising:
a Converged Wireless System (CWS); and
a Het Net Gateway (HNG) in communication with the CWS;
wherein the CWS receives a packet; performs Prediction Function (PF) feature extraction on the packet; performs, using a light weight AI model, traffic type classification for the packet based on the feature extraction; and performs Learning Function (LF) feature extraction on the packet;
wherein the HNG determines, using a heavy weight AI model, features and predictions for the packet; classifies the packet; and sends a determined traffic class to the light weight AI model.

12. The system of claim 11 wherein the HNG archives the features and predictions for the packet.

13. The system of claim 12 wherein the HNG trains the light weight AI model using the features and predictions of the packet.

14. The system of claim 11 wherein the PF feature extraction performed on the packet includes extracting at least one of a port number, a number of packets, a number of bytes, a packet inter-arrival time, a number of flows, or a flow duration.

15. The system of claim 11 wherein during virtual Radio Unit (vRU) bootup, an initial configuration is requested from a HetNet Gateway (HNG).

16. The system of claim 15 wherein the vRU requests parameters for the prediction function.

17. A non-transitory computer-readable medium containing instructions for providing intelligent traffic classification at a mobile edge using Artificial Intelligence (AI), which, when executed, cause the system to perform steps comprising:
receiving a packet;
performing Prediction Function (PF) feature extraction on the packet;
performing, using a light weight AI model, traffic type classification for the packet based on the feature extraction;
performing Learning Function (LF) feature extraction on the packet;
determining, using a heavy weight AI model, features and predictions for the packet;
classifying the packet by the heavy weight AI model; and
sending a determined traffic class to the light weight AI model.

18. The computer readable medium of claim 17 further comprising instructions for archiving the features and predictions for the packet.

19. The computer readable medium of claim 18 further comprising instructions for training the light weight AI model using the features and predictions of the packet.

20. The computer readable medium of claim 17 wherein instructions for performing Prediction Function (PF) feature extraction on the packet includes instructions for extracting at least one of a port number, a number of packets, a number of bytes, a packet inter-arrival time, a number of flows, or a flow duration.
